(19) United States
(12) Patent Application Publication
(10) Pub. No.: US 2026/0369244 A1
(43) Pub. Date: Nov. 19, 2026

(54) DISPLAY DEVICE AND METHOD FOR DRIVING DISPLAY DEVICE

(71) Applicant: LG Display Co., Ltd., Seoul (KR)

(72) Inventor: Woo Kyu SANG, Paju-si (KR)

(73) Assignee: LG Display Co., Ltd., Seoul (KR)

(21) Appl. No.: 19/558,956

(22) Filed: Mar. 6, 2026

(30) Foreign Application Priority Data
May 19, 2025 (KR) 10-2025-0064759

(51) Int. Cl. G09G 3/36; G09G 3/20

(52) U.S. Cl. CPC G09G 3/3677; G09G 3/2014; G09G 3/2092; G09G 3/3607; G09G 3/3614; G09G 3/3648; G09G 2300/0842; G09G 2310/0286; G09G 2340/0435

(57) ABSTRACT

A display device and a method for driving a display device are discussed. The display device can include a display panel in which a plurality of data lines, a plurality of gate lines, and a plurality of pixels are disposed. The display panel can include a first pixel area configured to display an image at a first refresh rate, and a second pixel area configured to display an image at a second refresh rate lower than the first refresh rate. In a first frame period, pulses of a gate clock signal are input to a gate driver while pixels of the first pixel area and the second pixel area are driven. In a second frame period, the pulses of the gate clock signal are input to the gate driver while the pixels of the first pixel area are driven.

### CROSS-REFERENCE TO RELATED APPLICATION

This application claims priority to and the benefit of Korean Patent Application No. 10-2025-0064759, filed in the Republic of Korea on May 19, 2025, the disclosure of which is hereby expressly incorporated by reference in its entirety.

### BACKGROUND

### Technical Field

The present disclosure relates to a display device for supporting a variable refresh rate (VRR) and a driving method thereof.

### Discussion of the Related Art

Recently, display devices can support Variable Refresh Rate (VRR). Variable refresh rate can variably change the frame update rate per second of images reproduced on the screen of the display device in real time, rather than maintaining it at a fixed value. Variable refresh rate can improve problems such as tearing or stuttering of images reproduced on the screen by adjusting the driving frequency of pixels to match the frames per second (FPS) of input images in content such as games or animations.

However, when pixels are driven at a variable refresh rate according to the driving characteristics of the display device, unexpected image quality degradation can be perceived. For example, when a portion where an image is displayed at a high refresh rate and a portion where an image is displayed at a low refresh rate are visible together on the screen, a luminance difference between pixel areas having different refresh rates can be perceived. For example, when images with different refresh rates are partitioned by area and displayed simultaneously on a screen of a display panel, a horizontal line can be visually perceived at a boundary between a high refresh rate area and a low refresh rate area.

### SUMMARY OF THE DISCLOSURE

The present disclosure aims to solve or address the aforementioned necessity and/or problems associated with the related art.

The technical problems to be addressed by the present disclosure are not limited to the problems mentioned above, and other problems not mentioned will be clearly understood by those skilled in the art from the description below.

A display device according to one embodiment of the present disclosure includes a display panel in which a plurality of data lines, a plurality of gate lines, and a plurality of pixels are disposed; a data driver electrically connected to the data lines and configured to output data voltages; a gate driver electrically connected to the gate lines and configured to output pulses of a gate signal in response to a gate clock signal; and a timing controller configured to control the data driver and the gate driver and to output the gate clock signal. The display panel includes a first pixel area configured to display an image at a first refresh rate; and a second pixel area configured to display an image at a second refresh rate lower than the first refresh rate. In a first frame period, pulses of the gate clock signal are input to the gate driver while pixels of the first pixel area and the second pixel area are driven. In a second frame period, the pulses of the gate clock signal are input to the gate driver while the pixels of the first pixel area are driven.

According to aspects of the present disclosure, the timing controller can adjust a pulse width of the gate clock signal to be larger when entering a driving period of the second pixel area.

According to aspects of the present disclosure, the timing controller can adjust a pulse width of the gate clock signal to be larger when driving a pixel line in which a proportion of pixel data having a high grayscale value equal to or greater than a preset reference grayscale value is equal to or greater than a preset reference proportion.

According to aspects of the present disclosure, the data driver can invert a polarity of the data voltage under the control of the timing controller. Sub-pixels of the first pixel area and the second pixel area can have polarities according to the polarity of the data voltage. Any one of the first pixel area and the second pixel area can include a boundary area in the second frame period. A sub-pixel polarity distribution of the boundary area can be different from a sub-pixel polarity distribution of a surrounding area outside the boundary area.

According to aspects of the present disclosure, the boundary area can be different from the surrounding area outside the boundary area in at least one of the polarity inversion cycle and the polarity inversion frequency.

According to aspects of the present disclosure, sub-pixels to which the data voltage may not applied have a polarity of previously charged data voltage.

According to aspects of the present disclosure, a polarity of the boundary area can be inverted in 1-dot inversion, and polarities of portions of the first pixel area and the second pixel area, excluding the boundary area, are inverted in column inversion.

According to aspects of the present disclosure, the boundary area within the first pixel area can be disposed adjacent to a boundary line between the first pixel area and the second pixel area. A density of a specific polarity in the boundary area can be smaller than that of portions of the first pixel area and the second pixel area, excluding the boundary area.

According to aspects of the present disclosure, the boundary area within the second pixel area can be disposed adjacent to a boundary line between the first pixel area and the second pixel area. A density of a specific polarity in the boundary area can be smaller than that of portions of the first pixel area and the second pixel area, excluding the boundary area.

According to aspects of the present disclosure, a density of a specific polarity of the boundary area can become higher toward the first pixel area.

According to aspects of the present disclosure, the boundary area within the second pixel area can be disposed adjacent to a boundary line between the first pixel area and the second pixel area. The boundary area can include one or more refresh pixel lines charged with a data voltage having a polarity opposite to that of a previous data voltage.

According to aspects of the present disclosure, a density of the refresh pixel lines can become higher toward the first pixel area.

According to aspects of the present disclosure, the gate driver can receive a carry clock signal. Pulses of the carry clock signal can input to the gate driver at a constant frequency while the pixels of the first pixel area and the second pixel area are driven.

According to aspects of the present disclosure, the gate driver can include signal transfer stages cascaded to receive the gate clock signal and the carry clock signal. Each of the signal transfer stages can include: a first pull-up transistor configured to supply a voltage of the carry clock signal to a first output terminal in response to a voltage of a first control node; a second pull-up transistor configured to supply a voltage of the gate clock signal to a second output terminal in response to the voltage of the first control node; a first pull-down transistor configured to electrically connect the first output terminal to a first voltage node in response to a voltage of a second control node; and a second pull-down transistor configured to electrically connect the second output terminal to a second voltage node in response to the voltage of the second control node.

A method for driving the display device according to one embodiment of the present disclosure includes partitioning a screen of a display panel into a first pixel area and a second pixel area having different refresh rates; in a first frame period, inputting pulses of a gate clock signal to a gate driver while pixels of the first pixel area and the second pixel area are driven, to supply the pulses of the gate clock signal to the pixels of the first pixel area and the second pixel area; and in a second frame period, inputting the pulses of the gate clock signal to the gate driver while the pixels of the first pixel area are driven, to supply the pulses of the gate clock signal to the pixels of the first pixel area.

According to aspects of the present disclosure, the method can further include adjusting a pulse width of the gate clock signal to be larger when entering a driving period of the second pixel area.

According to aspects of the present disclosure, the method can further include inverting a polarity of a data voltage applied to the pixels of the first pixel area and the second pixel area; and in a second frame period, controlling a sub-pixel polarity distribution of a boundary area, set in any one of the first pixel area or the second pixel area, to be different from that of a surrounding area outside the boundary area.

According to aspects of the present disclosure, the method can further include setting the boundary area within the second pixel area; and controlling a polarity of a data voltage charged in at least one pixel among the pixel lines of the boundary area to be opposite to that of a previous data voltage.

According to aspects of the present disclosure, the method can further include inputting pulses of a carry clock signal to the gate driver at a constant frequency while the pixels of the first pixel area and the second pixel area are driven.

According to aspects of the present disclosure, when images with different refresh rates are simultaneously displayed in a refresh area and a skip area partitioned within one screen, it is possible to minimize a luminance difference between the refresh area and the skip area and prevent a boundary between the refresh area and the skip area from being visually perceived.

According to aspects of the present disclosure, power consumption can be reduced because power is hardly consumed in the skip area.

However, the effects of the present disclosure are not limited to the above-mentioned effects, and other effects not mentioned will be clearly understood by those skilled in the art from the description of the invention described below.

### BRIEF DESCRIPTION OF THE DRAWINGS

The above and other objects, features, and advantages of the present disclosure will become more apparent to those of ordinary skill in the art by describing example embodiments of the present disclosure thereof in detail with reference to the attached drawings, in which:

FIG. 1 is a block diagram illustrating a display device according to an embodiment of the present disclosure;

FIG. 2 is a circuit diagram illustrating an example of a pixel circuit according to an embodiment of the present disclosure;

FIG. 3 is a circuit diagram illustrating an example of a data driver shown in FIG. 1 according to an embodiment of the present disclosure;

FIG. 4 is a diagram illustrating an example in which images with different refresh rates are displayed on a partitioned screen of a display panel according to an embodiment of the present disclosure;

FIG. 5 is a diagram illustrating a configuration of a gate driver according to an embodiment of the present disclosure;

FIG. 6 is a circuit diagram illustrating an example of a signal transfer stage shown in FIG. 5 in detail according to an embodiment of the present disclosure;

FIG. 7 is a waveform diagram illustrating input and output signals of the gate driver shown in FIG. 6 according to an embodiment of the present disclosure;

FIG. 8 is a waveform diagram illustrating an example of clock signals for controlling a refresh area and a skip area according to an embodiment of the present disclosure;

FIG. 9 is a waveform diagram illustrating gate clock signals and pulses of gate signals for driving gate lines of the refresh area according to an embodiment of the present disclosure;

FIGS. 10 and 11 are waveform diagrams illustrating examples of controlling the skip area by modulating the gate clock signals according to an embodiment of the present disclosure;

FIG. 12 is a waveform diagram illustrating an example of a method of controlling luminance of the refresh area and the skip area by modulating a pulse width of the clock signal according to an embodiment of the present disclosure; and

FIGS. 13 to 16 are diagrams illustrating pixel polarity control methods according to various embodiments of the present disclosure.

### DETAILED DESCRIPTION OF THE EMBODIMENTS

The advantages and features of the present disclosure and methods for accomplishing the same will be more clearly understood from embodiments of the present disclosure described below with reference to the accompanying drawings. However, the present disclosure is not limited to the following embodiments but can be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies can be omitted to avoid unnecessarily obscuring the subject matter of the present disclosure.

The terms such as “comprising,” “including,” “having,” and “consist of” used herein are generally intended to allow other components to be added unless the terms are used with the term “only.” Any references to singular can include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components can be interposed between them, unless “immediately” or “directly” is used.

When a temporal antecedent relationship is described, such as “after”, “following”, “next to”, “before”, or the like, it may not be continuous on a time base unless “immediately” or “directly” is used.

The terms such as “first,” “second,” and the like can be used to distinguish elements from each other, but the functions or structures of the components are not limited by ordinal numbers or component names in front of the components. Further, the term “can” fully encompasses all the meanings and coverages of the term “may” and vice versa.

The following embodiments of the present disclosure can be partially or entirely bonded to or combined with each other and can be linked and operated in technically various ways. The embodiments of the present disclosure can be carried out independently of or in association with each other.

The pixel circuit and the gate drive circuit of the display device can include a plurality of transistors. The transistor can be implemented as a thin film transistor (TFT). Transistors can be implemented as oxide thin film transistors (TFTs) including oxide semiconductors, LTPS TFTs including low temperature poly silicon (LTPS), a-Si TFTs including amorphous silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons can flow from a source to a drain. The n-channel transistor has a direction of a current flowing from the drain to the source. In the case of a p-channel transistor (p-channel metal-oxide semiconductor), since carriers are holes, a source voltage is higher than a drain voltage such that holes can flow from a source to a drain. In the p-channel transistor, since holes flow from the source to the drain, current flows from the source to the drain. It should be noted that a source and a drain of a transistor are not fixed. For example, a source and a drain can be changed according to an applied voltage. Therefore, the disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage can be a gate high voltage VGH, and the gate-off voltage can be a gate low voltage VGL. In the case of a p-channel transistor, the gate-on voltage can be the gate low voltage VGL, and the gate-off voltage can be the gate high voltage VGH.

Hereinafter, various embodiments of the present disclosure will be described in detail with reference to the accompanying drawings. All the components of each display device/apparatus according to all embodiments of the present disclosure are operatively coupled and configured. Hereinafter, the present disclosure will be described focusing on a liquid crystal display (LCD) as an example of a display device, but the present disclosure is not limited thereto.

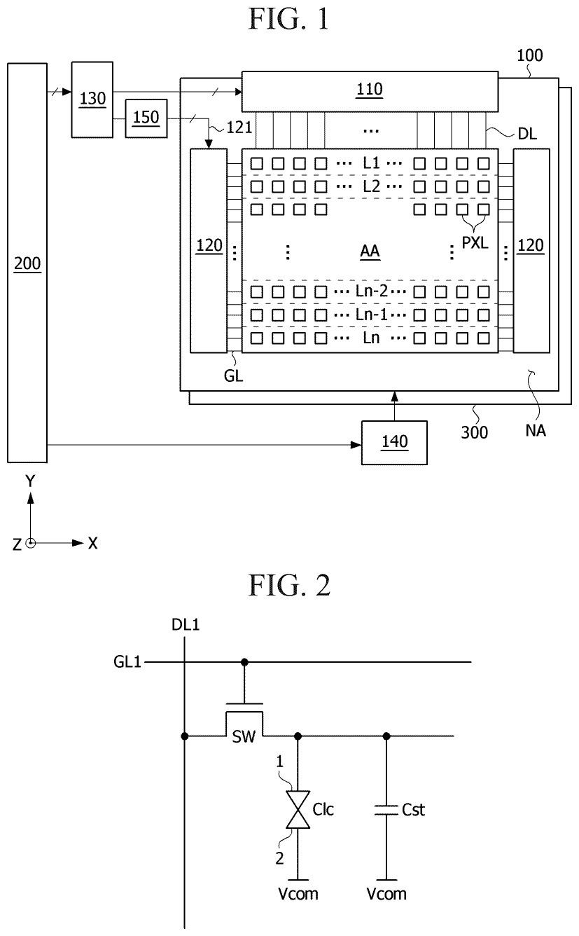

Referring to FIGS. 1 to 3, the display device according to an embodiment of the present disclosure includes a display panel 100, a timing controller 130, a data driver 110, and a gate driver 120.

The display panel 100 can be a panel having a rectangular shape with a width in an X-axis direction (or a first direction), a length in a Y-axis direction (or a second direction), and a thickness in a Z-axis direction (or a third direction), but is not limited thereto. The display panel 100 includes a screen on which an input image is displayed. The screen of the display panel 100 includes a pixel array for displaying the input image. The pixel array includes a plurality of data lines DL, a plurality of gate lines GL intersecting the data lines DL, and pixels PXL arranged in a matrix.

The data lines DL are disposed in the form of elongated wires along the Y-axis direction of the display panel 100 and are electrically connected to the output terminals of the data driver 110. The gate lines GL are arranged in the form of elongated wires along an X-axis direction of the display panel 100, intersect the data lines DL, and are electrically connected to output terminals of the gate driver 120.

The display panel 100 can include a liquid crystal layer filled between two transparent substrates. Each of the pixels PXL can be partitioned into a red sub-pixel, a green sub-pixel, and a blue sub-pixel for color representation. Each of the pixels PXL can further include a white sub-pixel.

Each of the sub-pixels can include a pixel circuit for driving a liquid crystal cell Clc, as shown in FIG. 2. Each pixel circuit is connected to a data line DL1 and a gate line GL1. The pixel circuit can be implemented as a circuit shown in FIG. 2, but is not limited thereto. The pixel circuit can include a transistor SW used as a switch element and a storage capacitor Cst. The transistor SW can be implemented as a thin film transistor (TFT). The transistor SW electrically connects the data line DL1 to a pixel electrode 1 in response to a pulse of a gate signal, thereby applying a data voltage Vdata to the pixel electrode 1. The transistor SW includes a gate electrode connected to the gate line GL1, a source electrode connected to the data line DL1, and a drain electrode connected to the pixel electrode 1. The storage capacitor Cst is connected between the pixel electrode 1 and a common electrode 2 to maintain a voltage applied to the liquid crystal cell Clc. The liquid crystal cell Clc includes liquid crystal molecules of a liquid crystal layer disposed between the pixel electrode 1 and the common electrode 2. The liquid crystal molecules are driven and rotated according to a voltage difference between a data voltage applied to the pixel electrode 1 and a common voltage Vcom applied to the common electrode 2, thereby changing the polarization characteristics of incident light.

A TFT array including the pixel circuits shown in FIG. 2 can be formed on a lower substrate of the display panel 100. A color filter array including a black matrix and color filters can be formed on an upper substrate of the display panel 100, but is not limited thereto. For example, the black matrix and the color filters can be disposed on the TFT array of the lower substrate. Polarizers are attached to the upper substrate and the lower substrate of the display panel 100, respectively, and alignment layers to set a pre-tilt angle of liquid crystals are formed thereon.

The common electrode 2 is formed on the upper substrate in a vertical electric field driving mode such as a twisted nematic (TN) mode and a vertical alignment (VA) mode, and is formed on the lower substrate together with the pixel electrode 1 in a horizontal electric field driving mode such as an in-plane switching (IPS) mode and a fringe field switching (FFS) mode.

The display panel 100 can be implemented not only in the twisted nematic (TN) mode, the vertical alignment (VA) mode, the in-plane switching (IPS) mode, and the fringe field switching (FFS) mode, but also in various liquid crystal modes. The liquid crystal display device can be implemented in any form such as a transmissive liquid crystal display device, a transflective liquid crystal display device, or a reflective liquid crystal display device. In the transmissive liquid crystal display device and the transflective liquid crystal display device, a backlight unit 300 is required. The backlight unit 300 can be implemented as a direct-type backlight unit or an edge-type backlight unit.

The display device further includes a power supply 140 and a level shifter 150.

The power supply 140 can include a charge pump, a regulator, a buck converter, and a boost converter, but is not limited thereto. The power supply 140 can receive a direct current (DC) input voltage from the host system 200 and generate power required to drive the display panel 100. The power supply 140 can output constant voltages, or DC voltages, such as a gamma reference voltage, a gate high voltage, a gate low voltage, and an IC driving voltage. The gamma reference voltage can be supplied to the data driver 110. The gate high voltage and the gate low voltage can be supplied to the level shifter 150 and the gate driver 120. The IC driving voltage is applied to a power terminal of an integrated circuit (IC) in which the circuits of the timing controller 130 and the data driver 110 are integrated, thereby driving the IC.

The timing controller (TCON) 130 transmits pixel data (or video data) of an input image received from the host system 200 to the data driver 110. The pixel data transmitted to the data driver 110 is digital data. The timing controller 130 receives timing signals such as a vertical synchronization signal Vsync, a horizontal synchronization signal Hsync, a data enable signal (Data Enable) DE, and a main clock signal. In FIG. 1, the timing signals are omitted. The timing controller 130 synchronizes the data driver 110 and the gate driver 120 based on the timing signals, and generates timing control signals for controlling each of the operation timings of the data and gate drivers 110 and 120. The vertical synchronization signal Vsync defines one frame period. The horizontal synchronization signal Hsync and the data enable signal DE have a cycle of one horizontal period. The data enable signal DE defines a valid data period in which the video data of the input image is present.

A display area AA includes a plurality of pixel lines L1 to Ln. Each of the pixel lines L1 to Ln includes one line of the sub-pixels arranged along a first direction X of the display panel 100. Pixels arranged in one pixel line can share the gate lines GL. The sub-pixels of one column arranged along a second direction Y share the same data line DL. One horizontal period is a time obtained by dividing one frame period by the total number of the pixel lines L1 to Ln.

Gate timing control signals output from the timing controller 130 can be input to the level shifter 150. The level shifter 150 receives the gate timing control signals having a digital signal voltage level and outputs a start signal and a clock signal swinging between a gate high voltage VGH and a gate low voltage VGL. The level shifter 150 can further output a stabilization signal in response to the gate timing control signals from the timing controller 130. Output signals of the level shifter 150 can be input to the gate driver 120 through clock wires 121 formed on the display panel 100. Signals output from the level shifter 150 are input to the gate driver 120. The gate driver 120 can be driven when a start signal and clock signals are input through the clock wires 121, and can output pulses of gate signals.

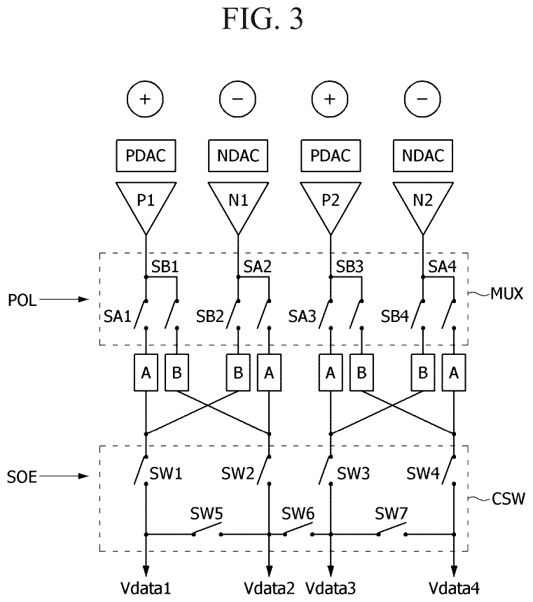

The timing controller 130 can encode data timing control signals into a control data packet and transmit the control data packet to the data driver 110. A video data packet including the control data packet and pixel data can be transmitted to the data driver 110 in the form of a differential signal through the same wires. The data timing control signals can include a polarity control signal POL and a source output enable signal SOE shown in FIG. 3. The polarity control signal POL controls a polarity of a data voltage applied to each of the sub-pixels. The polarity of a sub-pixel can be interpreted as being the same as the polarity of the data voltage. The source output enable signal SOE controls the output timing of the data driver 110 and charge sharing.

The data driver 110 includes a shift register, a latch, a digital-to-analog converter, hereinafter referred to as a DAC, and an output buffer. The data driver 110 converts pixel data of an input image serially received from the timing controller 130 into a parallel scheme using the shift register and the latch, and then inputs the converted pixel data to first and second DACs PDAC and NDAC shown in FIG. 3. A gamma reference voltage output from the power supply 140 can be distributed into gamma compensated voltages for respective gray levels through a voltage division circuit of the data driver 110 and be input to the first and second DACs PDAC and NDAC.

The first DAC PDAC converts pixel data into a positive-polarity gamma compensated voltage and outputs a positive-polarity data voltage. The positive-polarity data voltage is a voltage higher than a common voltage Vcom. The second DAC NDAC converts pixel data into a negative-polarity gamma compensated voltage and outputs a negative-polarity data voltage. The negative-polarity data voltage is a voltage lower than the common voltage Vcom. The data driver 110 can generate analog positive-polarity and negative-polarity gamma compensated voltages using a voltage division circuit (or a voltage divider circuit), for dividing a gamma reference voltage input from the power supply 140, and provides the generated voltages to the DACs. The data driver 110 further includes A-and B-switch elements SA1 to SA4 and SB1 to SB4 for selecting a polarity of the data voltage in response to a polarity control signal POL, as shown in FIG. 3. The data driver 110 outputs the data voltage to the data lines DL in response to the source output enable signal SOE.

The gate driver 120 can be disposed on the display panel 100. The gate driver 120 can be disposed in a non-display area NA outside a display area AA of the display panel 100, or at least partially disposed in the display area AA. The gate driver 120 can supply the gate signals to the gate lines GL in single feeding method or double feeding method. In the single feeding method, pulses of the gate signal can be applied at one end of the gate line GL. In the double feeding method, the pulses of the gate signal can be simultaneously applied at both ends of the gate line GL. The gate driver 120 can sequentially output the pulses of the gate signals using one or more shift registers to supply the pulses to the gate lines GL.

The host system 200 converts the resolution of an image signal provided from a video source to match the resolution of the display panel 100, and transmits the converted signal to the timing controller 130 together with the timing signals.

The data and gate drivers 110 and 120 for driving the display panel can drive pixels at a variable refresh rate under the control of the timing controller 130. The timing controller 130 can reduce the refresh rate of an image displayed on the display panel 100 to reduce power consumption of the display device or can increase the refresh rate to improve image quality, according to the frequency of the input image or based on the result of analyzing the input image. The variable refresh rate can vary the refresh frequencies of the pixels to, for example, 1 Hz, 30 Hz, 60 Hz, 120 Hz, 144 Hz, 165 Hz, or 240 Hz, but is not limited thereto.

A driving frequency of the pixels PXL can be classified into a refresh frequency at which pixel data is written to the pixels to update the pixel data, and a skip frequency at which pixel data is not written to the sub-pixels. The refresh frequency is a frequency generated when pixel data is written to pixels at a number of frames per second corresponding to a variable refresh rate. In contrast, the skip frequency is a frequency at which new pixel data is not written to the sub-pixels and a data voltage of pixel data charged during a previous refresh period is maintained. The skip frequency is significantly lower than the refresh driving frequency. When sub-pixels are driven at the skip frequency, power consumption is minimally incurred.

A unit of the variable refresh rate is Hertz (Hz). When a refresh rate is 60 Hz, pixel data is written to pixels at each frame period corresponding to 60 frames per second, and when the refresh rate is increased to 120 Hz, pixel data is written to pixels at each frame period corresponding to 120 frames per second. In a display device that supports a variable refresh rate, a refresh driving frequency of the pixels at which pixel data is written to the pixels varies according to the variable refresh rate.

Under the control of the timing controller 130, the data and gate drivers 110 and 120 for driving the display panel can reduce power consumption of the display device by lowering a driving frequency of the pixels PXL to a skip frequency when a still image is input for a predetermined time or longer, and can increase the refresh frequency of the pixels according to a refresh rate of the input image to implement image quality optimized for the content of the input image. The refresh rate of the display device can be lowered when the display device operates in a standby mode or in response to a user command. In addition, the refresh rate can be lowered in an always-on display (AOD) screen. The AOD screen can be a pixel area occupying a portion of the display area AA in which preset information, such as the remaining battery power and time, is displayed in the standby mode.

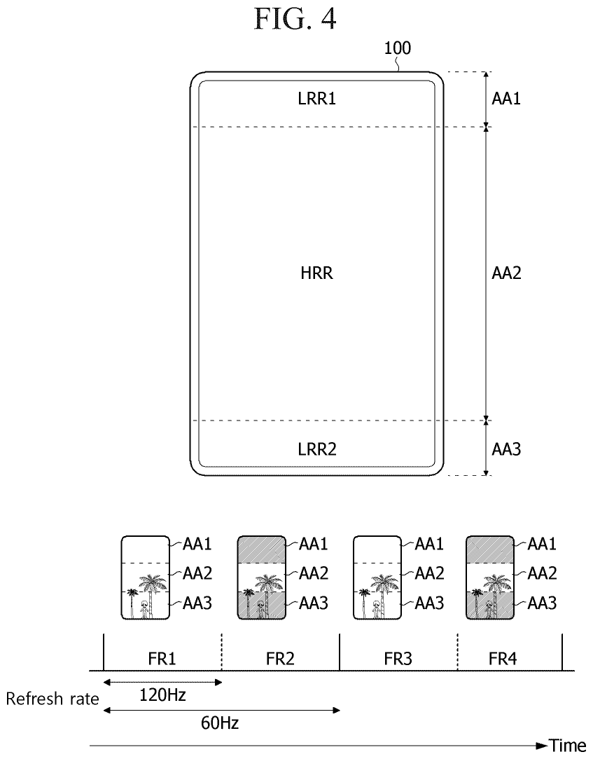

The timing controller 130 can determine a pixel area in which a high refresh rate image is displayed and a pixel area in which a low refresh rate image is displayed, based on a result of comparing pixel data between the previous frame image input in the previous frame period and stored in the memory and the current frame image input in the current frame period. As shown in FIG. 4, within one frame period, the high refresh rate image is displayed in a pixel area occupying a portion of a display area AA of the display panel 100 under the control of the timing controller 130, while the low refresh rate image is displayed in another pixel area. In a given frame period, the sub-pixels of the pixel area in which the high refresh rate image is displayed can be driven at the refresh frequency, while simultaneously, the sub-pixels of the pixel area in which the low refresh rate image is displayed can be driven at the skip frequency lower than refresh frequency.

In the case of a liquid crystal display device, a polarity of a data voltage applied to pixels is inverted to prevent direct current bias, image sticking, and the like. Polarity inversion methods include dot inversion, column inversion, line inversion, frame inversion, and the like. Two or more of these inversion methods can be applied together in combination. In dot inversion, the polarities of the sub-pixels, which are determined according to the polarity of the data voltage, is inverted on a dot-by-dot basis. A dot can be interpreted as a sub-pixel. For example, in N-dot inversion, where N is a natural number, the polarities of the sub-pixels are controlled using the polarity control signal POL generated by the timing controller 130 such that the polarities of the sub-pixels are inverted in units of N sub-pixels. In column inversion, the polarities of the sub-pixels are controlled using the polarity control signal POL such that the sub-pixels arranged along the Y-axis on the display panel 100 have the same polarity, while the polarities of adjacent sub-pixels arranged along the X-axis are opposite to each other. In line inversion, the polarities of the sub-pixels are controlled using the polarity control signal POL such that the sub-pixels arranged along the X-axis on the display panel 100 have the same polarity, while the polarities of adjacent sub-pixels arranged along the Y-axis are opposite to each other. These inversion methods invert the polarities of the sub-pixels at predetermined time intervals, for example, in each frame period.

FIG. 3 is a circuit diagram illustrating an example of the data driver shown in FIG. 1. In FIG. 3, “+” denotes a positive polarity, and “−” denotes a negative polarity.

Referring to FIG. 3, the data driver includes a plurality of first-DACs PDAC, a plurality of second DACs NDAC, output buffers P1, P2, N1, and N2 connected to the output terminals of the first and second DACs PDAC and NDAC, a polarity switching unit MUX that switches the path of the data voltage in response to the polarity control signal POL, and an output switching unit CSW that outputs the data voltage in response to the source output enable signal SOE. Each of the polarity switching unit MUX and the output switching unit CSW can be implemented as a multiplexer including a plurality of switching elements, but is not limited thereto.

The first DAC PDAC converts the pixel data into a positive-polarity gamma compensated voltage to output a positive-polarity data voltage. The second DAC NDAC converts the pixel data into a negative-polarity gamma compensated voltage to output a negative-polarity data voltage. The output voltages of the first and second DACs PDAC and NDAC are input to the polarity switching unit MUX through the corresponding output buffers P1, P2, N1, and N2. The polarity switching unit MUX switches the path of the positive/negative polarity data voltage according to the logic value of the polarity control signal POL. The polarity switching unit MUX can include a plurality of A-switching elements SA1 to SA4 and a plurality of B-switching elements SB1 to SB4. The switching elements SA1 to SB4 can be implemented as transistors which are turned on/off in response to the polarity control signal POL. The A-switching elements SA1 to SA4 can be turned on in response to a first logic value of the polarity control signal POL, for example, a high voltage, and turned off in response to a second logic value of the polarity control signal POL, for example, a low voltage. The B-switching elements SB1 to SB4 can be turned on in response to the second logic value of the polarity control signal POL and turned off in response to the first logic value of the polarity control signal POL.

The data driver 110 can invert the polarity of the data voltage applied to the data lines DL through the output terminals in response to the polarity control signal POL.

The A-switching elements SA1 to SA4 can be turned on during a first period to output the data voltage through the output terminals connected to an A-path. As a result, during the first period, a first data voltage Vdata1 of a positive polarity voltage can be output through the first output terminal, and a third data voltage Vdata3 of the positive polarity voltage can be output through the third output terminal. At the same time, a second data voltage Vdata2 of a negative polarity voltage can be output through the second output terminal, and a fourth data voltage Vdata4 of the negative polarity voltage can be output through the fourth output terminal. The first period can be a horizontal period or a frame period.

The B-switching elements SB1 to SB4 can be turned on during a second period to output the data voltage through the output terminals connected to a B-path. As a result, during the second period, the second data voltage Vdata2 of the positive polarity voltage can be output through the second output terminal, and the fourth data voltage Vdata4 of the positive polarity voltage can be output through the fourth output terminal. At the same time, the first data voltage Vdata1 of the negative polarity voltage can be output through the first output terminal, and the third data voltage Vdata3 of the negative polarity voltage can be output through the third output terminal. The second period can be a horizontal period or a frame period.

The output switching unit CSW can include a plurality of switching elements SW1 to SW7 that, depending on the logic value of the source output enable signal SOE, either transfer the positive/negative polarity data voltage to the output terminals or short-circuit adjacent output terminals. The switching elements SW1 to SW7 can be implemented as transistors which are turned on/off in response to the logic value of the source output enable signal SOE. The pulse period of the source output enable signal SOE can be one horizontal period. The pulse voltage of the source output enable signal SOE can be a high voltage. The first to fourth switching elements SW1 to SW4 can be turned on in response to a low voltage of the source output enable signal SOE to supply the positive/negative polarity data voltage to the corresponding output terminals. The fifth to seventh switching elements SW5 to SW7 can be turned on in response to a high voltage of the source output enable signal SOE to short-circuit adjacent output terminals. In this case, the voltages of the output terminals are averaged, which can reduce the transition width when the polarity of the data voltage applied to the data lines is inverted, thereby reducing power consumption.

FIG. 4 is a diagram illustrating an example in which images with different refresh rates are displayed on a partitioned screen of a display panel. In FIG. 4, HRR denotes a refresh area in which an image is displayed at a high refresh rate, and LRR1 and LRR2 denote skip areas in which an image is displayed at a low refresh rate. Each of the refresh area and the skip area can include a plurality of pixels partitioned within the display area AA of the screen.

Referring to FIG. 4, the screen of the display panel 100 can be partitioned into pixel areas AA1, AA2, and AA3 with different refresh rates. The pixel areas AA1, AA2, and AA3 can be local pixel areas which are not physically separated within the screen but are distinguished according to their refresh rates. The pixel areas AA1, AA2, and AA3 include the pixels and the data and gate lines DL and GL having substantially the same structure.

The pixels PXL of each of the pixel areas AA1, AA2, and AA3 can be driven at a refresh frequency or a skip frequency under the control of the timing controller 130. The timing controller 130 can determine a refresh rate of an input image in real time to vary the sizes and positions of the pixel areas AA1, AA2, and AA3 in each frame period. For example, the upper and lower portions of the input image can be displayed in the first and third pixel areas AA1 and AA3 at a low refresh rate, for example, 60 Hz. At the same time, the central portion of the input image can be displayed in the second pixel area AA2 at a high refresh rate, for example, 120 Hz. The refresh rates of the first pixel area AA1 and the third pixel area AA3 can be the same as or different from each other.

One frame period of the display device can include one or more refresh periods in which the pixel data is updated in the pixels, and one or more frame skip periods in which the pixel data is not updated in the pixels. The refresh area includes pixels into which the pixel data is written by being scanned by pulses of a gate signal synchronized with a data voltage during the refresh period. The pixels of the refresh area are driven at a refresh frequency. The skip area includes pixels that maintain a previous data voltage without pixel data being written during the skip period. The pixels of the skip area are driven at a skip frequency. The pixels of the skip area are not supplied with pulses of the gate signal.

In the example of FIG. 4, the pixels of the first and third pixel areas AA1 and AA3 are driven at the refresh frequency during first and third frame periods FR1 and FR3, while being driven at the skip frequency during second and fourth frame periods FR2 and FR4. The pixels of the second pixel area AA2 are driven at the refresh frequency in each frame period during the first to fourth frame periods FR1, FR2, FR3, and FR4. During the second frame period FR2, the first and third pixel areas AA1 and AA3 are the skip areas in which the pixel data is not written, while the second pixel area AA2 is the refresh area in which the pixel data is written.

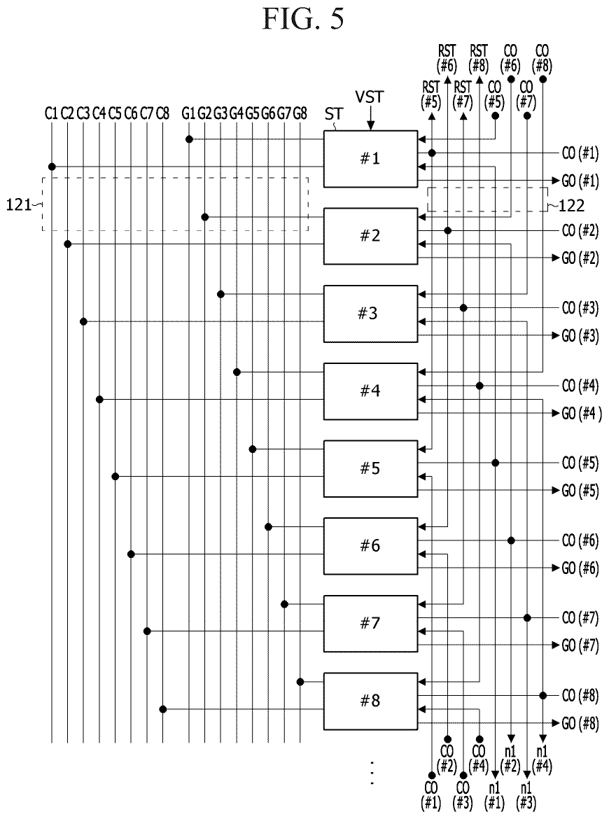

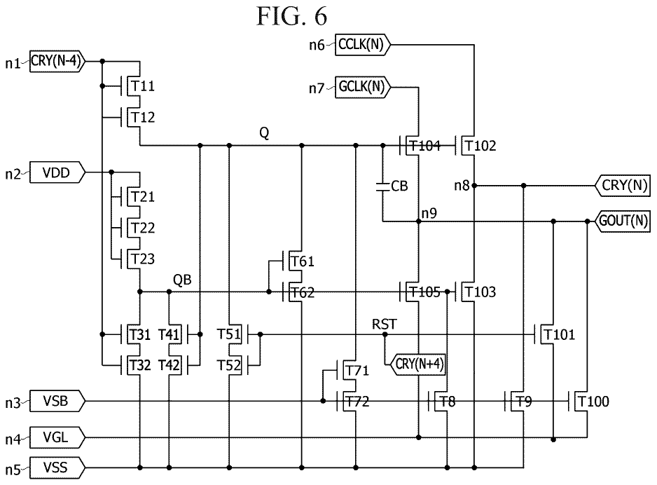

FIG. 5 is a diagram illustrating a configuration of a gate driver according to an embodiment of the present disclosure. In FIG. 5, the reference numerals “C1 to C8” denote carry clock signals, and “G1 to G8” denote gate clock signals. Here, “CO(#1) to CO(#8)” denote carry signals output from signal transfer stages, and “GO(#1) to GO(#8)” denote gate signals output from corresponding signal transfer stages ST#1 to ST#8. Further, “#1 to #8” denote numbers of the signal transfer stages. Also, “RST” denotes a third control node to which a pulse of an (N+4)-th (N is a natural number) carry signal is transferred (refer to FIG. 6), and “n1” denotes a first input node to which a pulse of an (N−4)-th carry signal is transferred (refer to FIG. 6).

Referring to FIG. 5, the gate driver 120 includes a plurality of signal transfer stages ST#1 to ST#8 cascaded through clock wires 121 and carry signal wires 122. The clock wires 121 and the carry signal wires 122 can be disposed on the display panel 100. The gate driver 120 can receive a start signal VST and the carry and gate clock signals C1 to C8 and G1 to G8 to output pulses of the carry signals CO(#1) to CO(#8) and the gate signals GO(#1) to GO(#8).

A pulse of a start signal VST is input to the first signal transfer stage ST#1. Pulses of the carry signals CO(#1) to CO(#7) received from the previous signal transfer stages are input to the start signal nodes of the second to eighth signal transfer stages ST#2 to ST#8, which are cascaded to the first signal transfer stage ST#1.

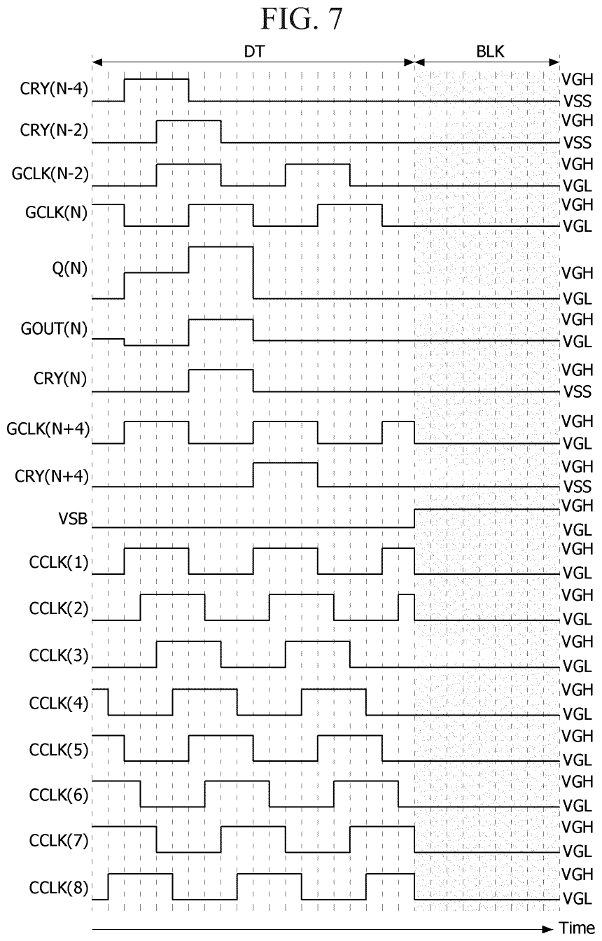

FIG. 6 is a circuit diagram illustrating an example of the signal transfer stage shown in FIG. 5 in detail. The signal transfer stage shown in FIG. 6 is an N-th signal transfer stage. The circuit of the signal transfer stage is not limited to the example of FIG. 6. FIG. 7 is a waveform diagram illustrating input and output signals of the gate driver shown in FIG. 6. In FIGS. 6 and 7, “CCLK(N)” and “CCLK(1) to CCLK(8)” are carry clock signals input to the signal transfer stage. The N-th carry clock signal CCLK(N) can be any one of the carry clock signals C1 to C8 shown in FIG. 5. The N-th gate clock signal GCLK(N) can be any one of the gate clock signals G1 to G8 shown in FIG. 5. Here, “CRY(N−4) to CRY(N+4)” are carry signals output from the signal transfer stages. The N-th carry signal CRY(N) output from the N-th signal transfer stage can be any one of the carry signals CO(#1) to CO(#8) shown in FIG. 5. The N-th gate signal GOUT(N) output from the N-th signal transfer stage can be any one of the gate signals GO(#1) to GO(#8) shown in FIG. 5.

Referring to FIGS. 6 and 7, each of the signal transfer stages of the gate driver 120 includes a first control node Q, a second control node QB, a third control node RST, and a plurality of transistors T11 to T105. Each of the transistors T11 to T105 can be implemented as an n-channel TFT, but the present disclosure is not limited thereto.

The first transistors T11 and T12 are connected between a first input node n1 and the first control node Q. When the first transistors T11 and T12 are turned on, the first input node n1 can be electrically connected to the first control node Q. A pulse of the start signal VST or a pulse of the previous carry signal output from a previous signal transfer stage is input to the first input node n1 as a start signal. For example, the previous carry signal can be the (N−4)-th carry signal CRY(N-4), but is not limited thereto. The first transistors T11 and T12 can include a first-first transistor T11 and a first-second transistor T12 connected in series between the first input node n1 and the first control node Q, but are not limited thereto. Such a series connection structure of the transistors can reduce leakage current in an off-state of the transistors. The first-first transistor T11 includes a gate electrode and a first electrode connected to the first input node n1, and a second electrode connected to a first electrode of the first-second transistor T12. The first-second transistor T12 includes a gate electrode connected to the first input node n1, a first electrode connected to the first-first transistor T11, and a second electrode connected to the first control node Q.

The second transistors T21, T22, and T23 are connected between a second input node n2 and the second control node QB. When the second transistors T21, T22, and T23 are turned on, the second input node n2 can be electrically connected to the second control node QB. The high-potential driving voltage VDD supplied from the power supply 140 can be applied to the second input node n2. The high-potential driving voltage VDD can be a constant voltage of, for example, 16V, which is the same as a gate high voltage VGH, but is not limited thereto. A structure in which the high-potential driving voltage VDD is applied to the gate driver 120 independently of the gate high voltage VGH can reduce a phenomenon in which a polarizing film attached to the display panel 100 is overheated due to the driving time of the last signal transfer stage is longer than that of other signal transfer stages. Separating the high-potential driving voltage VDD from the gate high voltage VGH allows for more precise control of these voltages, thereby improving the stability and reliability of the gate driver 120. Depending on the driving method, applying only the necessary voltage to the gate driver 120 can reduce power consumption and increase the driving efficiency thereof.

The second transistors T21, T22, and T23 can include a second-first transistor T21, a second-second transistor T22, and a second-third transistor T23 connected in series between a second input node n2 and the second control node QB, but are not limited thereto. This series connection structure of the second-first transistor T21, the second-second transistor T22, and the second-third transistor T23 can reduce leakage current in an off-state of the transistors and provide an effect of distributing the accumulation of DC gate bias stress on the transistors. The second transistors T21, T22, and T23 charge the second control node QB during a gate-off period, excluding a period in which a pulse of the gate signal GOUT(N) is output, thereby discharging the first control node Q to maintain it in an off-state. In this process, a DC voltage is applied to gate electrodes of sixth transistors T61 and T62 and pull-down transistors T103 and T105 for most of the time, which can increase the gate bias stress of these transistors T61, T62, T103, and T105. The stress of these transistors can be distributed by the second transistors T21, T22, and T23.

The second-first transistor T21 includes a gate electrode and a first electrode connected to the second input node n2, and a second electrode connected to a first electrode of the second-second transistor T22. The second-second transistor T22 includes a gate electrode connected to the second input node n2, a first electrode connected to the second electrode of the second-first transistor T21, and a second electrode connected to the first electrode of the second-third transistor T23. The second-third transistor T23 includes a gate electrode connected to the second input node n2, a first electrode connected to the second-second transistor T22, and a second electrode connected to the second control node QB.

The third transistors T31 and T32 are connected between the second control node QB and a fifth input node n5. A low-potential voltage VSS or a ground voltage output from the power supply 140 is applied to the fifth input node n5. The low-potential voltage VSS can be a constant voltage lower than a gate low voltage VGL, for example, −16V, but is not limited thereto. The gate low voltage VGL can be −12V, but is not limited thereto. The third transistors T31 and T32 are turned on when a voltage of the first input node n1 is the gate high voltage VGH to electrically connect the second control node QB to the fifth input node n5, thereby discharging the second control node QB and controlling it to an off-state. The low-potential voltage VSS is set to a voltage lower than the gate low voltage VGL, which can improve negative bias temperature illumination stress (NBTIS) of the transistors. The NBTIS represents a degradation characteristic of a transistor that is accelerated over time by a reverse bias voltage in a light and high-temperature environment.

The third transistors T31 and T32 can include a third-first transistor T31 and a third-second transistor T32 connected in series between the second control node QB and the fifth input node n5, but are not limited thereto. The third-first transistor T31 includes a gate electrode connected to the first input node n1, a first electrode connected to the second control node QB, and a second electrode connected to a first electrode of the third-second transistor T32. The third-second transistor T32 includes a gate electrode connected to the first input node n1, a first electrode connected to the third-first transistor T31, and a second electrode connected to the fifth input node n5.

The fourth transistors T41 and T42 are connected between the second control node QB and the fifth input node n5. The fourth transistors T41 and T42 are turned on when the first control node Q is in an on-state with its voltage charged to the gate high voltage VGH or higher, thereby electrically connecting the second control node QB to the fifth input node n5. The fourth transistors T41 and T42 can include a fourth-first transistor T41 and a fourth-second transistor T42 connected in series between the second control node QB and the fifth input node n5, but are not limited thereto. The fourth-first transistor T41 includes a gate electrode connected to the first control node Q, a first electrode connected to the second control node QB, and a second electrode connected to a first electrode of the fourth-second transistor T42. The fourth-second transistor T42 includes a gate electrode connected to the first control node Q, a first electrode connected to the fourth-first transistor T41, and a second electrode connected to the fifth input node n5.

The fifth transistors T51 and T52 are connected between the first control node Q and the fifth input node n5. The fifth transistors T51 and T52 are turned on when a voltage of the third control node RST is the gate high voltage VGH to electrically connect the first control node Q to the fifth input node n5, thereby discharging the first control node Q and controlling it to an off-state. A pulse of a next carry signal output from a subsequent signal transfer stage can be input to the third control node RST. The voltage of the third control node RST can be charged to the gate high voltage VGH by the voltage of the pulse of the next carry signal. In an example, the next carry signal can be an (N+4)-th carry signal CRY(N+4), but is not limited thereto.

The fifth transistors T51 and T52 can include a fifth-first transistor T51 and a fifth-second transistor T52 connected in series between the first control node Q and the fifth input node n5, but are not limited thereto. The fifth-first transistor T51 includes a gate electrode connected to the third control node RST, a first electrode connected to the first control node Q, and a second electrode connected to a first electrode of the fifth-second transistor T52. The fifth-second transistor T52 includes a gate electrode connected to the third control node RST, a first electrode connected to the fifth-first transistor T51, and a second electrode connected to the fifth input node n5.

The sixth transistors T61 and T62 are connected between the first control node Q and the fifth input node n5. The sixth transistors T61 and T62 are turned on when a voltage of the second control node QB is the gate high voltage VGH to electrically connect the first control node Q to the fifth input node n5. The sixth transistors T61 and T62 can include a sixth-first transistor T61 and a sixth-second transistor T62 connected in series between the first control node Q and the fifth input node n5, but are not limited thereto. The sixth-first transistor T61 includes a gate electrode connected to the second control node QB, a first electrode connected to the first control node Q, and a second electrode connected to a first electrode of the sixth-second transistor T62. The sixth-second transistor T62 includes a gate electrode connected to the second control node QB, a first electrode connected to the sixth-first transistor T61, and a second electrode connected to the fifth input node n5.

The seventh transistors T71 and T72 are connected between the first control node Q and the fifth input node n5. The seventh transistors T71 and T72 are turned on when a voltage of the third input node n3 is the gate high voltage VGH to electrically connect the first control node Q to the fifth input node n5. A stabilization signal VSB can be applied to the third input node n3. The stabilization signal VSB can be output from the level shifter 150 and applied to the third input node n3 through one of the clock wires 121. The stabilization signal VSB controls the first and second control nodes Q and QB and the output nodes n8 and n9 to an off-state during a blank period BLK in which there is no pixel data of an input image, for example, during the vertical blank period shown in FIG. 7. In FIG. 7, “DT” is a display period in which pixels are driven.

The seventh transistors T71 and T72 can include a seventh-first transistor T71 and a seventh-second transistor T72 connected in series between the first control node Q and the fifth input node n5, but are not limited thereto. The seventh-first transistor T71 includes a gate electrode connected to the third input node n3, a first electrode connected to the first control node Q, and a second electrode connected to a first electrode of the seventh-second transistor T72. The seventh-second transistor T72 includes a gate electrode connected to the third input node n3, a first electrode connected to the seventh-first transistor T71, and a second electrode connected to the fifth input node n5.

The eighth transistor T8 is turned on in response to the gate high voltage VGH of the stabilization signal VSB to electrically connect the second control node QB to the fifth input node n5. The eighth transistor T8 includes a gate electrode connected to the third input node n3, a first electrode connected to the second control node QB, and a second electrode connected to the fifth input node n5. The ninth transistor T9 is turned on in response to the gate high voltage VGH of the stabilization signal VSB to electrically connect the first output node n8 to the fifth input node n5. A pulse of the N-th carry signal CRY(N) is output through the first output node n8. The ninth transistor T9 includes a gate electrode connected to the third input node n3, a first electrode connected to the first output node n8, and a second electrode connected to the fifth input node n5. The tenth transistor T100 is turned on in response to the gate high voltage VGH of the stabilization signal VSB to electrically connect the second output node n9 to the fourth input node n4. A pulse of the N-th gate signal GOUT(N) is output through the second output node n9. The tenth transistor T100 includes a gate electrode connected to the third input node n3, a first electrode connected to the second output node n9, and a second electrode connected to the fourth input node n4.

The eleventh transistor T101 is turned on when a voltage of the third control node RST is the gate high voltage VGH to electrically connect the second output node n9 to the fourth input node n4, thereby discharging the second output node n9 down to the gate low voltage VGL. The gate low voltage VGL output from the power supply 140 is applied to the fourth input node n4. The eleventh transistor T101 includes a gate electrode connected to the third control node RST, a first electrode connected to the second output node n9, and a second electrode connected to the fourth input node n4.

The twelfth and thirteenth transistors T102 and T103 output a pulse of the N-th carry signal CRY(N) through the first output node n8. The twelfth transistor T102 is a pull-up transistor connected between a sixth input node n6 and the first output node n8. The twelfth transistor T102 can be turned on when a voltage of the first control node Q is the gate high voltage VGH to electrically connect the sixth input node n6 to the first output node n8. When the twelfth transistor T102 is turned on, the first output node n8 is charged with a pulse voltage of an N-th carry clock signal CCLK(N), i.e., the gate high voltage VGH, causing the voltage of the N-th carry signal CRY(N) to rise to the gate high voltage VGH. The twelfth transistor T102 includes a gate electrode connected to the first control node Q, a first electrode connected to the sixth input node n6, and a second electrode connected to the first output node n8. The thirteenth transistor T103 is a pull-down transistor connected between the first output node n8 and the fifth input node n5. The thirteenth transistor T103 is turned on when a voltage of the second control node QB is the gate high voltage VGH to electrically connect the first output node n8 to the fifth input node n5, thereby discharging the voltage of the first output node n8 to the low-potential voltage VSS. The thirteenth transistor T103 includes a gate electrode connected to the second control node QB, a first electrode connected to the first output node n8, and a second electrode connected to the fifth input node n5.

The fourteenth and fifteenth transistors T104 and T105 output a pulse of the N-th gate signal GOUT(N) through the second output node n9. The fourteenth transistor T104 is a pull-up transistor connected between a seventh input node n7 and the second output node n9. A capacitor CB can be connected between the first control node Q and the second output node n9. The fourteenth transistor T104 can be turned on when a voltage of the first control node Q is boosted to a gate high voltage VGH or higher to electrically connect the seventh input node n7 to the second output node n9. When the fourteenth transistor T104 is turned on, the second output node n9 is charged with a pulse voltage of an N-th gate clock signal GCLK(N), i.e., the gate high voltage VGH, causing the voltage of the N-th gate signal GOUT(N) to rise to the gate high voltage VGH. As the voltage of the second output node n9 rises, bootstrapping occurs through the capacitor CB, allowing the voltage of the first control node Q to be boosted to the gate high voltage VGH or higher. The fourteenth transistor T104 includes a gate electrode connected to the first control node Q, a first electrode connected to the seventh input node n7, and a second electrode connected to the second output node n9. The fifteenth transistor T105 is a pull-down transistor connected between the second output node n9 and the fourth input node n4. The fifteenth transistor T105 is turned on when a voltage of the second control node QB is the gate high voltage VGH to electrically connect the second output node n9 to the fourth input node n4, thereby discharging the voltage of the second output node n9 to the gate low voltage VGL. The fifteenth transistor T105 includes a gate electrode connected to the second control node QB, a first electrode connected to the second output node n9, and a second electrode connected to the fourth input node n4.

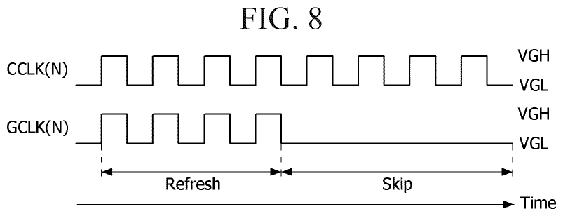

FIG. 8 is a waveform diagram illustrating an example of clock signals for controlling a refresh area and a skip area.

Referring to FIG. 8, the signal transfer stages of the gate driver 120 receive clock signals CCLK(N) and GCLK(N). The clock signals CCLK(N) and GCLK(N) are classified into a carry clock signal CCLK(N) and a gate clock signal GCLK(N). Each of the signal transfer stages outputs a pulse of a carry signal CRY(N) in response to a pulse of the carry clock signal CCLK(N). The carry signal CRY(N) is transferred to a subsequent signal transfer stage and serves as a start signal for the subsequent signal transfer stage. Each of the signal transfer stages outputs a pulse of a gate signal GOUT(N) in response to a pulse of the gate clock signal GCLK(N). The pulse of the gate signal GOUT(N) is applied to a gate electrode of a transistor SW disposed in each of the sub-pixels. The pulse of the gate signal GOUT(N) can be synchronized with a data voltage Vdata of the pixel data. Accordingly, the pixels can update the pixel data by charging the data voltage Vdata in response to the pulse of the gate signal GOUT(N).

When the screen of the display panel 100 is partitioned into two or more pixel areas displaying images with different refresh rates as shown in FIG. 4, the refresh area and the skip area can be controlled by the gate clock signal GCLK(N). Since a pulse of the gate signal can be output from a signal transfer stage when a pulse of the gate clock signal GCLK(N) is input thereto, a period in which the pulse of the gate clock signal GCLK(N) is generated can be controlled as a refresh period in which pixels of the refresh area are driven. A period in which the voltage of the gate clock signal GCLK(N) is maintained at the gate low voltage without a pulse can be controlled as a skip period in which pixels of the skip area are skip-driven without data updates. The timing controller 130 can determine the refresh area and the skip area based on an analysis of the input image and modulate the gate clock signal GCLK(N) as shown in FIG. 8 to control the pixels of the refresh area and the skip area.

In order for the gate driver 120 to drive the gate lines across the entire screen of the display panel, a pulse of a carry signal should be input to each of the signal transfer stages. Accordingly, while a pulse of the carry clock signal CCLK(N) is input to each of the signal transfer stages driving the gate lines of the skip area, a pulse of the gate clock signal GCLK(N) is not input thereto.

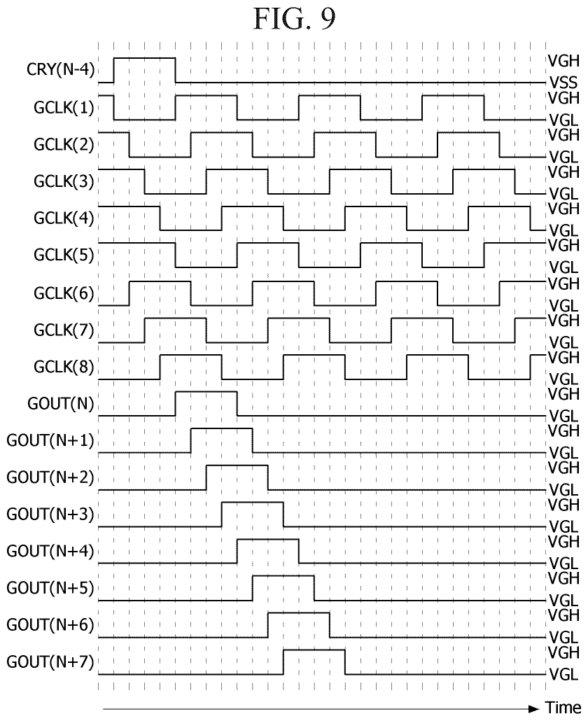

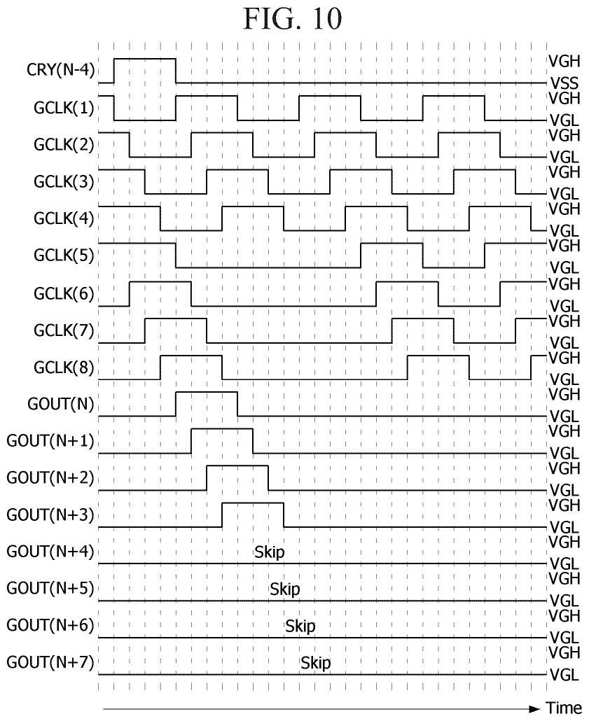

FIG. 9 is a waveform diagram illustrating gate clock signals and pulses of gate signals for driving gate lines of a refresh area. The pulses of the gate signals shown in FIG. 9 can be sequentially applied to the pixel lines of the pixel areas AA1, AA2, and AA3 during the first frame period FR1 in FIG. 4.

Referring to FIG. 9, the gate driver 120 can include signal transfer stages connected to the gate lines of the refresh area. The gate clock signals GCLK(1) to GCLK(8) input to these signal transfer stages include pulses that repeat at a constant cycle without variations in pulse period or frequency. When the phases of these gate clock signals GCLK(1) to GCLK(8) are sequentially shifted by one horizontal period, the signal transfer stages output pulses of the gate signals GOUT(N) to GOUT(N+7) in response to the pulses of the gate clock signals GCLK(1) to GCLK(8) and supply them to the gate lines of the refresh area while sequentially shifting each pulse by one horizontal period.

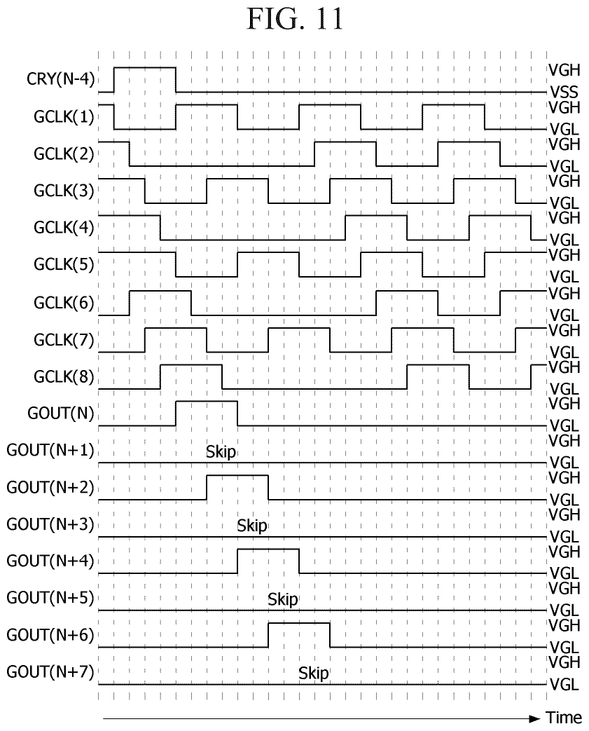

FIGS. 10 and 11 are waveform diagrams illustrating examples of controlling a skip area by modulating a gate clock signal. The pulses of the gate signals shown in FIG. 10 can be sequentially applied to the pixel lines of the first and second pixel areas AA1 and AA2 during the second frame period FR2 in FIG. 4.

Referring to FIG. 10, the first to fourth gate clock signals GCLK(1) to GCLK(4) can be input to the first to fourth signal transfer stages at a constant frequency without changes in pulse period and frequency. In this case, the first to fourth signal transfer stages sequentially output pulses of the gate signals GOUT(N) to GOUT(N+3) in response to the first to fourth gate clock signals GCLK(1) to GCLK(4). The pixels of the refresh area connected to the first to fourth signal transfer stages through the gate lines are driven at a refresh frequency to charge the data voltage of pixel data. The polarity of the sub-pixels can be inverted according to the polarity of the data voltage.

When the voltage of the fifth gate clock signal GCLK(5) is maintained at the gate low voltage VGL without a pulse after the pulses of the first to fourth gate clock signals GCLK(1) to GCLK(4) have been sequentially shifted, a pulse of the gate signal is not generated from the fifth signal transfer stage. Subsequently, when the voltages of the sixth to eighth gate clock signals GCLK(6) to GCLK(8) are maintained at the gate low voltage VGL without pulses, pulses of the gate signals are not generated from the fifth to eighth signal transfer stages. Pixels of the skip area connected to the sixth to eighth signal transfer stages through the gate lines do not charge the data voltage of the pixel data, but are driven by the previous data voltage stored in the capacitor Cst, and the polarity of these pixels does not change. Under the control of the timing controller 130, the gate clock signals GCLK(1) to GCLK(8) do not generate pulses when entering the skip area, thereby increasing the pulse period and decreasing the effective frequency. Accordingly, the timing controller 130 can vary the position and size of the skip area by modulating the gate clock signals GCLK(1) to GCLK(8) within the skip area. For example, the timing controller 130 can control the skip area in units of pixel lines, as shown in FIG. 11.

Referring to FIG. 11, the odd-numbered gate clock signals GCLK(1), GCLK(3), GCLK(5), and GCLK(7) include pulses generated at a constant frequency. In this case, pulses of the gate signals are normally output from the odd-numbered signal transfer stages, so that pixels of the odd-numbered pixel lines are charged with the data voltage to update the pixel data. The even-numbered gate clock signals GCLK(2), GCLK(4), GCLK(6), and GCLK(8) can be modulated such that pulses are absent in certain intervals. In this case, since the pulses of the gate signals are not output from the even-numbered signal transfer stages, the even-numbered pixel lines are skip-driven without pixel data updates, and the polarities of the sub-pixels do not change.

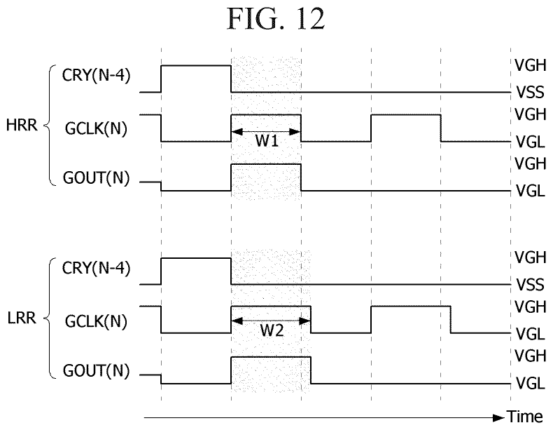

The refresh area and the skip area are partitioned within the screen, enabling images to be displayed simultaneously at different refresh rates. Since the driving frequencies of the pixels of the refresh area and the skip area are different from each other, a luminance difference can be perceived. In this case, as shown in FIG. 12, the timing controller 130 can reduce the luminance difference between the refresh area and the skip area by adjusting the pulse width of the gate clock signal GCLK(N) input to the gate driver 120.

In a frame period in which data voltages are applied only to pixels of the refresh area, for example, the second and fourth frame periods FR2 and FR4 shown in FIG. 4, pulses of the gate clock signal GCLK(N) can be generated while the pixels of the refresh area are driven, so that the pulses of the gate signals can be applied to the pixel lines of the refresh area. In a frame period in which data voltages are applied to pixels of both the refresh area and the skip area, for example, in the first and third frame periods FR1 and FR3 shown in FIG. 4, the pulses of the gate clock signal GCLK(N) can be generated while the pixels of the refresh area and the skip area are driven, so that the pulses of the gate signals can be applied to the pixel lines of the refresh area and the skip area.

When the luminance of the skip area is lower than that of the refresh area, as the pulse width of the gate clock signal GCLK(N) increases, the pulse width of the gate signal applied to the pixels of the skip area increases, thereby increasing the charging time of the data voltage. When the charging time of the data voltage in the pixels of the skip area increases, the amount of data voltage charged in the pixels increases accordingly, so that the luminance of the pixels can be increased. In the example of FIG. 12, “W1” is the pulse width of the gate signal GOUT(N) applied to pixels of a refresh area HRR in which an image is displayed at a high refresh rate. “W2” is the pulse width of the gate signal GOUT(N) applied to pixels of a skip area LRR in which an image is displayed at a low refresh rate. In the example of FIG. 12, the relationship between the pulse widths of the refresh area and the skip area can be W2>W1, but it is not limited thereto. The timing controller 130 can minimize the luminance difference between the refresh area and the skip area by modulating the pulse width of the gate clock signal GCLK(N) according to the refresh rate of an image to be displayed on the display panel 100.

As described above, the charging time of a pixel can be adjusted according to the pulse width of the gate clock signal GCLK(N). The timing controller 130 can analyze the image to be written to the pixels of the skip area, derive a grayscale value of pixel data having a relatively high weight, and change the pulse width of the gate clock signal GCLK(N) according to the derived grayscale value. For example, while the pixels of the skip area are being driven, the timing controller 130 can adjust a pulse width of the gate clock signal GCLK(N) to be larger at a scan timing when data voltages are applied to a pixel line in which a proportion of pixel data having a high grayscale value is equal to or greater than a preset reference proportion (e.g., 50% or more). In contrast, the timing controller 130 can adjust the pulse width of the gate clock signal GCLK(N) to be smaller if the grayscale value of the pixel data is relatively low. The timing controller 130 can adjust the pulse width of the gate clock signal GCLK(N) to be larger as the refresh rate [Hz] of the skip area (LRR) becomes lower.

When digital signals of the same grayscale value are converted into a positive polarity data voltage and a negative polarity data voltage, their voltage differences relative to a common voltage can differ from each other. In this case, even if the grayscale values of the pixel data are the same, a luminance difference can occur between a positive polarity sub-pixel and a negative polarity sub-pixel. A positive polarity pixel is a pixel to which a positive polarity data voltage is applied. A negative polarity pixel is a pixel to which a negative polarity data voltage is applied.

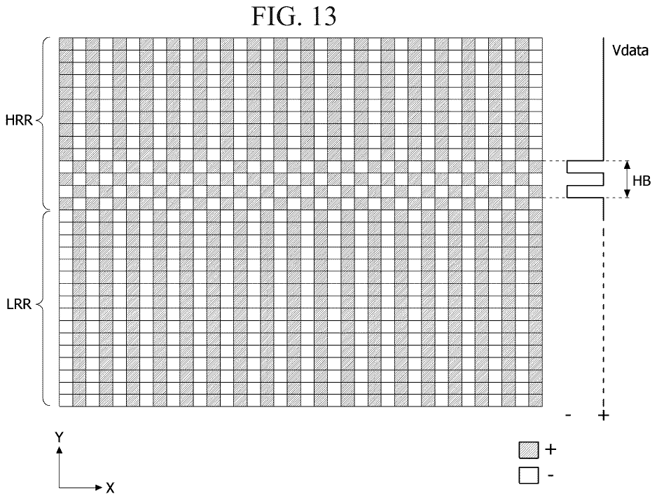

Since the pixel data is updated by applying the data voltages to the pixels of the refresh area, the polarities of the sub-pixels of the refresh area can be inverted. In contrast, since the data voltages are not applied to the pixels of the skip area, the polarities of the sub-pixels of the skip area are not inverted. Sub-pixels in the skip area are maintained with the polarity of the data voltage charged during the previous refresh period. In this case, the polarities of the sub-pixels at the boundary between the refresh area and the skip area become opposite to each other, causing a luminance difference between adjacent sub-pixels even at the same grayscale level, which can lead to the visibility of horizontal lines which are not present in the original image or a perceptible difference in color due to the luminance variance. Embodiments of the present disclosure can control the polarities of the sub-pixels using the methods shown in FIGS. 13 to 16 to reduce horizontal lines and color shifts at the boundary between the refresh area and the skip area.

FIGS. 13 to 16 are diagrams illustrating pixel polarity control methods according to various embodiments of the present disclosure. In FIGS. 13 to 16, “+” and “−” indicate the polarity of the data voltage Vdata applied to the sub-pixels. Redundant descriptions among the embodiments shown in FIGS. 13 to 16 will be omitted. In FIGS. 13 to 16, boundary areas HB and LB can be added in a frame period in which pixel data is updated in the refresh area but not updated in the skip area.

Referring to FIG. 13, the refresh area HRR includes a plurality of pixels which update pixel data by charging data voltages. In the refresh area HRR, the polarities of the sub-pixels can be inverted according to the polarities of the data voltages.

The skip area LRR includes a plurality of pixels which are not charged with a data voltage because no gate pulse is input, and thus, these pixels are driven by the voltage previously stored in the capacitor Cst. The data driver 110 outputs data voltages in synchronization with the pulses of the gate signals when the pixels of the refresh area HRR are sequentially scanned line by line, and can cease to output the data voltages upon entering the skip area LRR.

When the data voltages are applied only to the sub-pixels of the refresh area HRR and their polarities are inverted, a luminance difference can be perceived because the polarities of the sub-pixels adjacent in at least the second direction Y are inverted relative to each other at the boundary between the refresh area HRR and the skip area LRR. To reduce this luminance difference, the refresh area HRR can include a boundary area HB in which the polarity distribution of the sub-pixels differs from that of the surrounding sub-pixels. The position and size of the boundary area HB can be varied by the timing controller 130. The polarity distribution in the boundary area HB differs from that of the refresh area HRR, excluding the boundary area HB, and also differs from that of the skip area LRR. The polarity inversion cycle in the boundary area HB can be shorter than that of the refresh area HRR, excluding the boundary area HB, and the skip area LRR. Due to the boundary area HB, the polarity distribution between the refresh area HRR and the skip area LRR does not change abruptly, thereby reducing the luminance difference between the refresh area HRR and the skip area LRR.

From a frequency perspective, the polarity inversion frequency of the boundary area HB can be higher than that of the refresh area HRR, excluding the boundary area, and the skip area LRR. The density of positive polarity (or negative polarity) sub-pixels in the boundary area HB can be lower than that of the refresh area HRR, excluding the boundary area, and the skip area LRR. For example, as shown in FIG. 13, the polarity distribution of the boundary area HB can be 1-dot inversion, while the polarity distribution of the refresh area HRR, excluding the boundary area HB, and the skip area LRR can be column inversion, but it is not limited thereto. For example, the polarity distribution of the boundary area HB can be 1-dot inversion, while the polarity distribution of the refresh area HRR, excluding the boundary area HB, and the skip area LRR can be M-dot inversion (where M is a natural number of 2 or more), but it is not limited thereto.

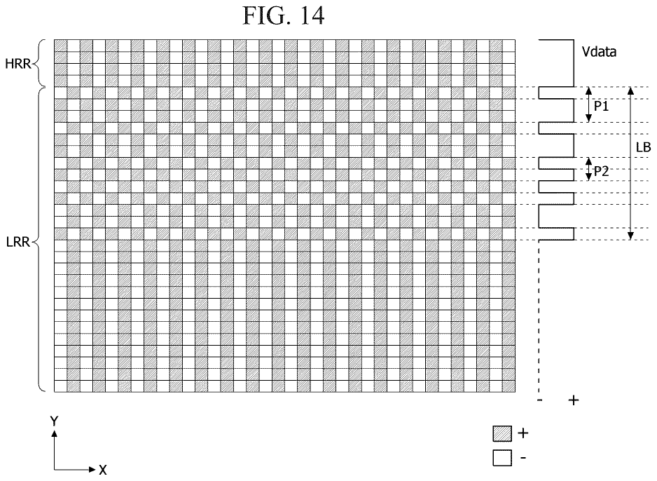

Referring to FIG. 14, the skip area LRR can include a boundary area LB in which the polarity distribution of the sub-pixels differs from that of surrounding sub-pixels. The boundary area LB includes a plurality of sub-pixels. The polarities of some sub-pixels in the boundary area LB can be inverted without updating the pixel data. For example, when a pulse of the gate signal is applied to sub-pixels of a specific pixel line and the same data voltage as that of a previous frame is applied to the sub-pixels, the pixel data is not updated with different data, but the polarities of the sub-pixels can be inverted according to the polarity of the data voltage. The polarity distribution of the boundary area LB is different from that of both the skip area LRR, excluding the boundary area LB, and the refresh area HRR. The polarity inversion periods P1 and P2 of the boundary area LB can vary. From a frequency perspective, the polarity inversion frequency of the boundary area LB can be higher than that of the skip area LRR, excluding the boundary area LB, and the refresh area HRR. In terms of polarity distribution, the density of positive polarity (or negative polarity) sub-pixels in the boundary area LB can be lower than that of the skip area LRR, excluding the boundary area LB, and the refresh area HRR when viewed along the Y-axis direction. The density of positive polarity (or negative polarity) sub-pixels in the boundary area LB can gradually increase as it approaches the refresh area HRR when viewed along the Y-axis direction.

Referring to FIG. 14, the polarity distribution of the boundary area LB is a distribution in which 1-dot inversion and 2-dot inversion are applied together, and the polarity distribution of the skip area LRR, excluding the boundary area LB, and the refresh area HRR can be column inversion, but it is not limited thereto. For example, the polarity distribution of the boundary area LB can be 1-dot inversion, and the polarity distribution of the skip area LRR, excluding the boundary area LB, and the refresh area HRR can be 4-dot inversion, but it is not limited thereto.

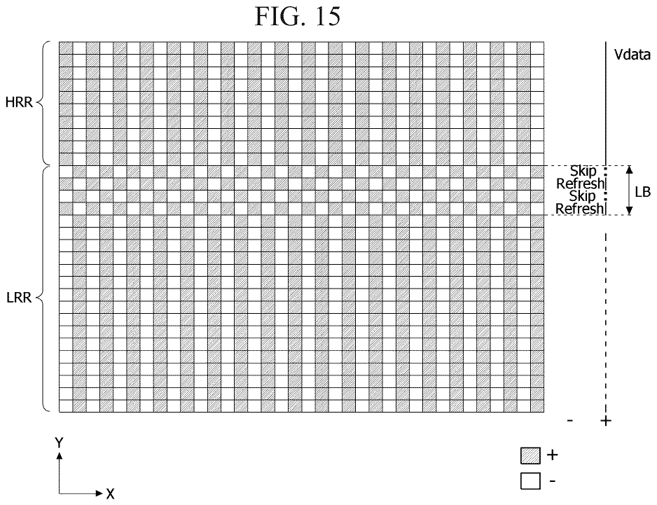

Referring to FIG. 15, the skip area LRR can include a boundary area LB in which the polarity distribution of the sub-pixels differs from that of surrounding sub-pixels. The skip area LRR includes one or more pixel lines that are charged with a data voltage whose polarity is inverted relative to a previous frame. For example, the boundary area LB can include odd-numbered pixel lines driven at a skip frequency and even-numbered pixel lines that receive pulses of a gate signal and a data voltage to be driven at a refresh frequency.

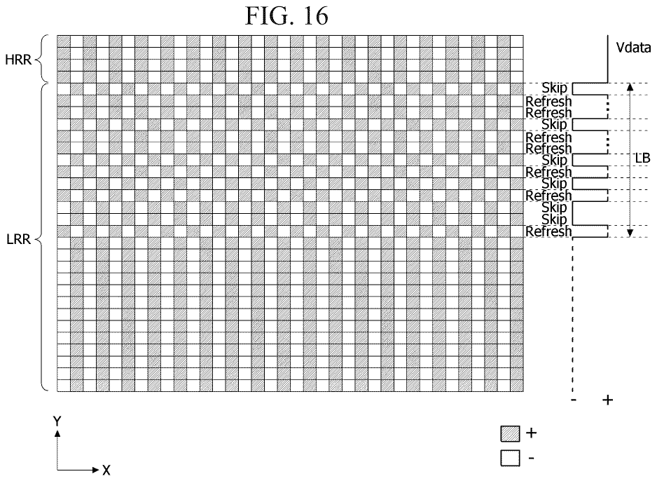

Referring to FIG. 16, the density of pixel lines driven at a refresh frequency to have their polarities inverted in the boundary area LB can gradually increase as it approaches the refresh area HRR when viewed along the Y-axis direction. In this case, the density of positive polarity (or negative polarity) sub-pixels in the boundary area LB can increase as it approaches the refresh area HRR.

The timing controller 130 can adjust a pulse width of the gate clock signal GCLK(N) to be larger at a scan timing of a pixel line if a grayscale value of pixel data input to sub-pixels disposed on a refresh pixel line of the boundary area LB is relatively high. In contrast, the timing controller 130 can adjust the pulse width of the gate clock signal GCLK(N) to be smaller if the grayscale value of the pixel data is relatively low. The timing controller 130 can adjust the pulse width of the gate clock signal GCLK(N) to be larger at the scan timing of the refresh pixel lines in the boundary area LB as the refresh rate [Hz] of the skip area LRR becomes lower.

According to one or more embodiments of the present disclosure, the display device can be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the present disclosure can be applied to organic light emitting lighting devices or inorganic light emitting lighting devices.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and can be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A display device comprising:
a display panel in which a plurality of data lines, a plurality of gate lines, and a plurality of pixels are disposed;
a data driver electrically connected to the plurality of data lines and configured to output data voltages;
a gate driver electrically connected to the plurality of gate lines and configured to output a gate signal in response to a gate clock signal; and
timing controller configured to control the data driver and the gate driver and output the gate clock signal,
wherein the display panel includes:
a first pixel area configured to display an image at a first refresh rate; and
a second pixel area configured to display an image at a second refresh rate lower than the first refresh rate,
wherein in a first frame period, pulses of the gate clock signal are input to the gate driver while pixels of the first pixel area and the second pixel area are driven, and
wherein in a second frame period, the pulses of the gate clock signal are input to the gate driver while the pixels of the first pixel area are driven.

2. The display device of claim 1, wherein the timing controller is configured to adjust a pulse width of the gate clock signal to be larger when entering a driving period of the second pixel area.

3. The display device of claim 1, wherein the timing controller is configured to adjust a pulse width of the gate clock signal to be larger, when driving a pixel line in which a proportion of pixel data having a high grayscale value equal to or greater than a preset reference grayscale value is equal to or greater than a preset reference proportion.

4. The display device of claim 1, wherein the data driver is configured to invert a polarity of a data voltage among the data voltages under control of the timing controller,
wherein sub-pixels of the first pixel area and the second pixel area have polarities according to the polarity of the data voltage,
wherein any one of the first pixel area and the second pixel area includes a boundary area in the second frame period, and
wherein a sub-pixel polarity distribution of the boundary area is different from a sub-pixel polarity distribution of a surrounding area outside the boundary area.

5. The display device of claim 4, wherein the boundary area is different from the surrounding area outside the boundary area in at least one of a polarity inversion cycle and a polarity inversion frequency.

6. The display device of claim 4, wherein sub-pixels to which the data voltage is not applied have a polarity of a previously charged data voltage.

7. The display device of claim 4, wherein a polarity of the boundary area is inverted in 1-dot inversion, and polarities of portions of the first pixel area and the second pixel area, excluding the boundary area, are inverted in a column inversion.

8. The display device of claim 4, wherein the boundary area within the first pixel area is disposed adjacent to a boundary line between the first pixel area and the second pixel area, and
wherein a density of a specific polarity in the boundary area is smaller than that of portions of the first pixel area and the second pixel area, excluding the boundary area.

9. The display device of claim 4, wherein the boundary area within the second pixel area is disposed adjacent to a boundary line between the first pixel area and the second pixel area, and
wherein a density of a specific polarity in the boundary area is smaller than that of portions of the first pixel area and the second pixel area, excluding the boundary area.

10. The display device of claim 4, wherein a density of a specific polarity of the boundary area becomes higher toward the first pixel area.

11. The display device of claim 4, wherein the boundary area within the second pixel area is disposed adjacent to a boundary line between the first pixel area and the second pixel area, and
the boundary area includes one or more refresh pixel lines configured to be charged with a data voltage having a polarity opposite to that of a previous data voltage.

12. The display device of claim 11, wherein a density of the refresh pixel lines becomes higher toward the first pixel area.

13. The display device of claim 1, wherein the gate driver is configured to further receive a carry clock signal, and
wherein pulses of the carry clock signal are input to the gate driver at a constant frequency while the pixels of the first pixel area and the second pixel area are driven.

14. The display device of claim 13, wherein the gate driver includes signal transfer stages cascaded to receive the gate clock signal and the carry clock signal, and
wherein each of the signal transfer stages includes:
a first pull-up transistor configured to supply a voltage of the carry clock signal to a first output terminal in response to a voltage of a first control node; and
a second pull-up transistor configured to supply a voltage of the gate clock signal to a second output terminal in response to the voltage of the first control node.

15. The display device of claim 14, wherein each of the signal transfer stages further includes:
a first pull-down transistor configured to electrically connect the first output terminal to a first voltage node in response to a voltage of a second control node; and
a second pull-down transistor configured to electrically connect the second output terminal to a second voltage node in response to the voltage of the second control node.

16. A method for driving a display device including a display panel, the method comprising:
partitioning a screen of the display panel into a first pixel area and a second pixel area having different refresh rates;
in a first frame period, inputting pulses of a gate clock signal to a gate driver while pixels of the first pixel area and the second pixel area are driven, to supply the pulses of the gate clock signal to the pixels of the first pixel area and the second pixel area; and
in a second frame period, inputting the pulses of the gate clock signal to the gate driver while the pixels of the first pixel area are driven, to supply the pulses of the gate clock signal to the pixels of the first pixel area.

17. The method of claim 16, further comprising adjusting a pulse width of the gate clock signal to be larger when entering a driving period of the second pixel area.

18. The method of claim 16, further comprising:
inverting a polarity of a data voltage applied to the pixels of the first pixel area and the second pixel area; and
in the second frame period, controlling a sub-pixel polarity distribution of a boundary area, set in any one of the first pixel area or the second pixel area, to be different from that of a surrounding area outside the boundary area.

19. The method of claim 18, further comprising:
setting the boundary area within the second pixel area; and
controlling a polarity of a data voltage charged in at least one pixel among pixel lines of the boundary area to be opposite to that of a previous data voltage.

20. The method of claim 16, further comprising:
inputting pulses of a carry clock signal to the gate driver at a constant frequency while the pixels of the first pixel area and the second pixel area are driven.
